(19) United States
(12) Patent Application Publication
(10) Pub. No.: US 2020/0002146 A1
(43) Pub. Date: Jan. 2, 2020

(54) BOTTLE OPENER AND RESEALER

(71) Applicant: Bruno Widmann, DeKalb, IL (US)

(72) Inventor: Bruno Widmann, DeKalb, IL (US)

(21) Appl. No.: 16/024,742

(22) Filed: Jun. 30, 2018

(51) Int. Cl. B67B 7/44; B67B 7/16; B67B 7/18; B67B 7/00

(52) U.S. Cl. CPC B67B 7/44; B67B 7/24; B67B 7/18; B67B 7/16

(57) ABSTRACT

The present disclosure provides bottle opener and resealer devices comprising a frustoconical cap gripping element for accommodating bottle caps of various diameters.

### FIELD

The present disclosure provides bottle opener and resealer devices comprising a frustoconical cap gripping element for accommodating bottle caps of various diameters.

### BACKGROUND

Release of threaded metal and plastic caps from bottles (e.g., drink bottles) is typically very difficult, especially when the caps are still under their original factory-manipulated seal. Metal caps are typically pried from the bottle to break the original seal, which makes them difficult or impossible to reseal with the same threaded or crimped metal cap. Commercially available tools for removing threaded plastic caps typically only accommodate a small range of cap diameters, and are formed of materials that tend to slide over, rather than grip, the threaded plastic cap, especially when the outside surface of the cap is wet. Still others require the user to squeeze the tool in order to enhance the tool's grip on the cap, which can be problematic or painful for some users.

A need persists for an efficient tool for removing and replacing various types of bottle caps.

### SUMMARY

The present disclosure provides a device for opening bottles that are sealed by various types of caps, including threaded metal caps, crimped metal caps (also referred to as crown caps), and threaded plastic caps, and cans sealed by metal lids; and for resealing said bottles after the plastic or metal cap has been loosened.

Bottle opener and resealer devices of the present disclosure generally comprise a frustoconical cap gripping element for accommodating bottle caps of various diameters. In some embodiments, a bottle opener and resealer device of the present disclosure may further comprise a cap lever element, a can piercer, and/or a lift-tab bar.

In some embodiments, the present disclosure provides a bottle opener and resealer comprising a frustoconical cap gripping element disposed on a first, bottom face of the bottle opener and resealer, wherein the frustoconical cap gripping element is for engaging with a top rim of a bottle cap and comprises at least two cap gripping ridges disposed on an inner surface of the frustoconical cap gripping element.

In some embodiments, the present disclosure provides a bottle opener and resealer comprising a cap-lever element at a first end of the bottle opener and resealer; a can piercer at a second end of the bottle opener and resealer; and a frustoconical cap gripping element for engaging with a top rim of a bottle cap, the frustoconical cap gripping element disposed between the first end and the second end of the bottle opener and resealer.

In some embodiments, the present disclosure provides a bottle opener and resealer comprising a cap-lever element at a first end of the bottle opener and resealer; a can piercer at a second end of the bottle opener and resealer; a lift-tab bar at the second end of the bottle opener and resealer and disposed on a top face of the bottle opener and resealer; a frustoconical cap gripping element for engaging with a top rim of a bottle cap, the frustoconical cap gripping element disposed between the first end and the second end of the bottle opener and resealer and on a bottom face of the bottle opener and resealer, the frustoconical cap gripping element comprising cap gripping ridges disposed on an inner surface of the frustoconical cap gripping element; and a grip enhancing element between the first end and the second end of the bottle opener and resealer and disposed on the top face of the bottle opener and resealer, the grip enhancing element comprising four cap gripping ridges disposed on an inner side wall surface of the grip enhancing element, and two cap teeth disposed on the inner side wall surface and an inner top surface of the grip enhancing element.

These and other embodiments are described more fully in the following Detailed Description and accompanying Figures.

### BRIEF DESCRIPTION OF THE FIGURES

FIG. 1 shows a perspective view of a bottle opener and resealer according to one embodiment of the present disclosure.

FIG. 2 shows a top plan view of the bottle opener and resealer of FIG. 1.

FIG. 3 shows a side plan view of the bottle opener and resealer of FIG. 1.

FIG. 4 shows a schematic of use of the bottle opener and resealer of FIG. 1 to engage the rim of a screw cap on a bottle.

The figures depict various embodiments of this disclosure for purposes of illustration only. One skilled in the art will readily recognize from the following discussion that alternative embodiments of the structures and methods illustrated herein may be employed without departing from the principles of embodiments described herein.

### DETAILED DESCRIPTION

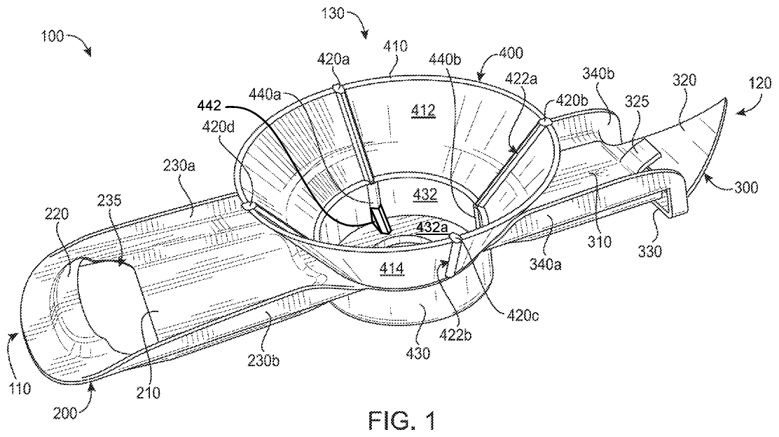

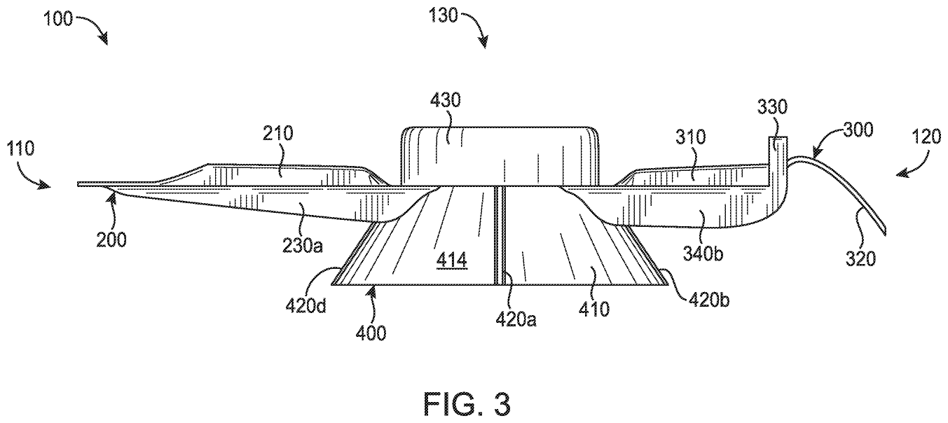

Referring generally to FIGS. 1-4, the present disclosure provides bottle opener and resealer devices and methods of using same to open and reseal a bottle B, such as a beverage bottle, that is sealed with a threaded metal or plastic cap C, or a metal crimp cap (also referred to as a crown cap).

1. Bottle Opener and Resealer Devices

Bottle opener and resealer devices 100 according to the present disclosure generally comprise a frustoconical cap gripping element 400. In some embodiments, a bottle opener and resealer device 100 according to the present disclosure further comprises a cap lever element 200, a can piercer 300, and/or a lift-tab bar 330. These components may be arranged in various ways relative to each other in a bottle opener and resealer device 100.

Referring now to FIGS. 1-4, the frustoconical cap gripping element 400 comprises a progressively expanded gripping section 410. The progressively expanded gripping section 410 may in some embodiments be frustoconical shaped, such as in the embodiment shown in FIG. 1. In other embodiments, the progressively expanded gripping section 410 may feature another shape(s), such as a dome, a square frustum, a pentagonal frustum, a hexagonal frustum, a heptagonal frustum, an octagonal frustum, or any other regular polygonal frustum. The progressively expanded gripping section 410 is oriented such that the minimum diameter (or minimum width if regular polygonal frustum-shaped) is nearest the base 310 of the bottle opener and resealer 100, and the maximum diameter (or maximum width if regular polygonal frustum-shaped) is farthest from the base 310 of the bottle opener and resealer 100.

The frustoconical cap gripping element 400 may be disposed in any relative arrangement to other elements of the bottle opener and resealer 100, such as the cap lever element 200, the can piercer 300, and the lift-tab bar 330. In some embodiments, such as those shown in FIGS. 1-4, for example, the frustoconical cap gripping portion 400 is located within a middle portion 130 of the bottle opener and resealer 100.

In some embodiments, the maximum diameter (or maximum width if regular polygonal frustum-shaped) of the progressively expanded gripping section 410 may be at least about 2 inches. In some embodiments, the maximum diameter (or maximum width if regular polygonal frustum-shaped) of the progressively expanded gripping section 410 may be at least about 3 inches. In some embodiments, the maximum diameter (or maximum width if regular polygonal frustum-shaped) of the progressively expanded gripping section 410 may be at least about 4 inches. In some embodiments, the maximum diameter (or maximum width if regular polygonal frustum-shaped) of the progressively expanded gripping section 410 may be no more than about 4 inches. In some embodiments, the maximum diameter (or maximum width if regular polygonal frustum-shaped) of the progressively expanded gripping section 410 may be no more than about 3 inches. In some embodiments, the maximum diameter (or maximum width if regular polygonal frustum-shaped) of the progressively expanded gripping section 410 may be no more than about 2 inches. In some embodiments, the maximum diameter (or maximum width if regular polygonal frustum-shaped) of the progressively expanded gripping section 410 is about 2 inches, about 2.5 inches, about 3 inches, about 3.5 inches, about 4 inches, about 4.5 inches, about 5 inches, or about 5.5 inches.

In some embodiments, the minimum diameter (or minimum width if regular polygonal frustum-shaped) of the progressively expanded gripping section 410 may be no more than about 1 inch. In some embodiments, the minimum diameter (or minimum width if regular polygonal frustum-shaped) of the progressively expanded gripping section 410 may be no more than about 0.75 inches. In some embodiments, the minimum diameter (or minimum width if regular polygonal frustum-shaped) of the progressively expanded gripping section 410 may be no more than about 0.5 inches. In some embodiments, the minimum diameter (or minimum width if regular polygonal frustum-shaped) of the progressively expanded gripping section 410 may be at least about 0.5 inches. In some embodiments, the minimum diameter (or minimum width if regular polygonal frustum-shaped) of the progressively expanded gripping section 410 may be at least about 0.75 inches. In some embodiments, the minimum diameter (or minimum width if regular polygonal frustum-shaped) of the progressively expanded gripping section 410 may be at least about 1 inch. In some embodiments, the minimum diameter (or minimum width if regular polygonal frustum-shaped) of the progressively expanded gripping section 410 may be at least about 1.25 inches. In some embodiments, the minimum diameter (or minimum width if regular polygonal frustum-shaped) of the progressively expanded gripping section 410 may be at least about 1.5 inches. In some embodiments, the minimum diameter (or minimum width if regular polygonal frustum-shaped) of the progressively expanded gripping section 410 is about 0.5 inches, about 0.75 inches, about 1 inches, about 1.25 inches, about 1.5 inches, about 1.75 inches, or about 2 inches.

The frustoconical cap gripping element 400 may be attached to the base 310 of the bottle opener and resealer 100 by any suitable means including, for example, by one or more screws, by one or more spot welds, by one or more contiguous welds, or by a continuous weld.

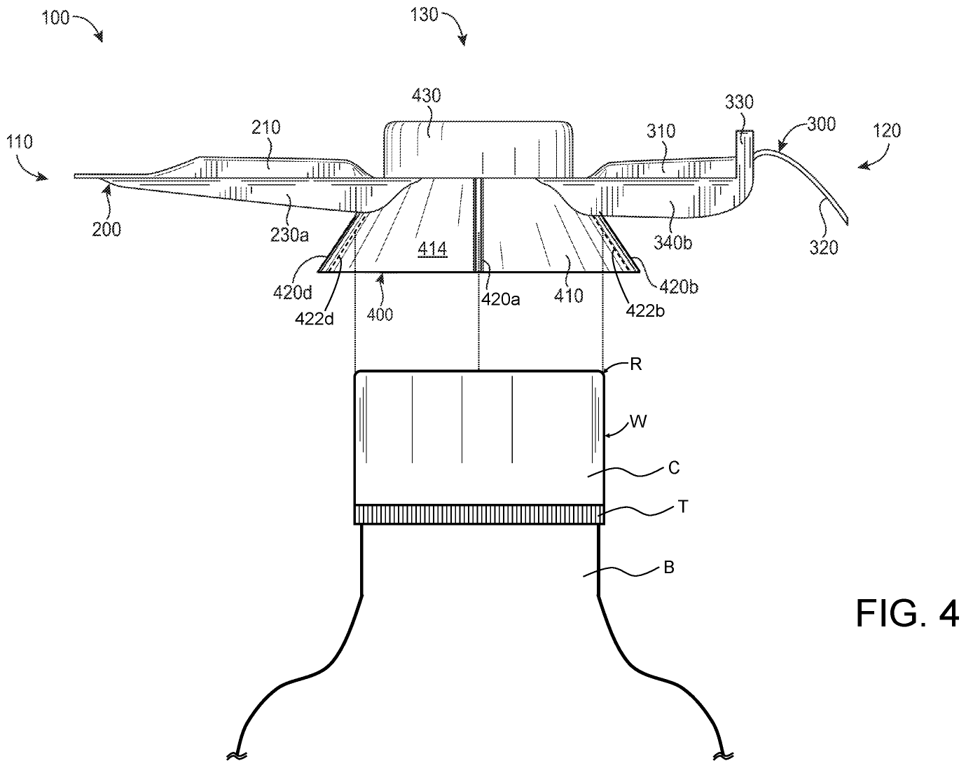

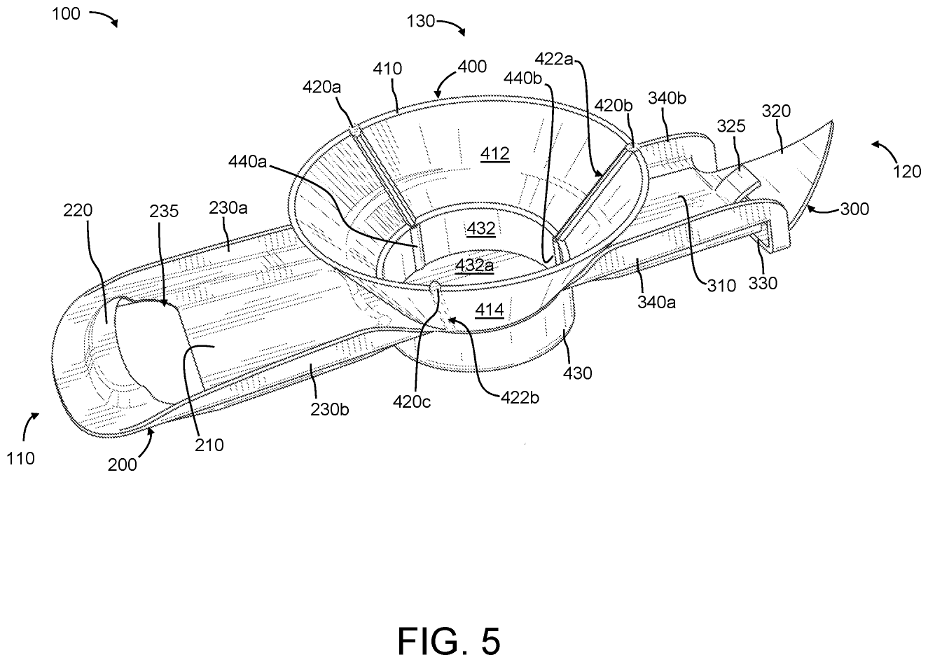

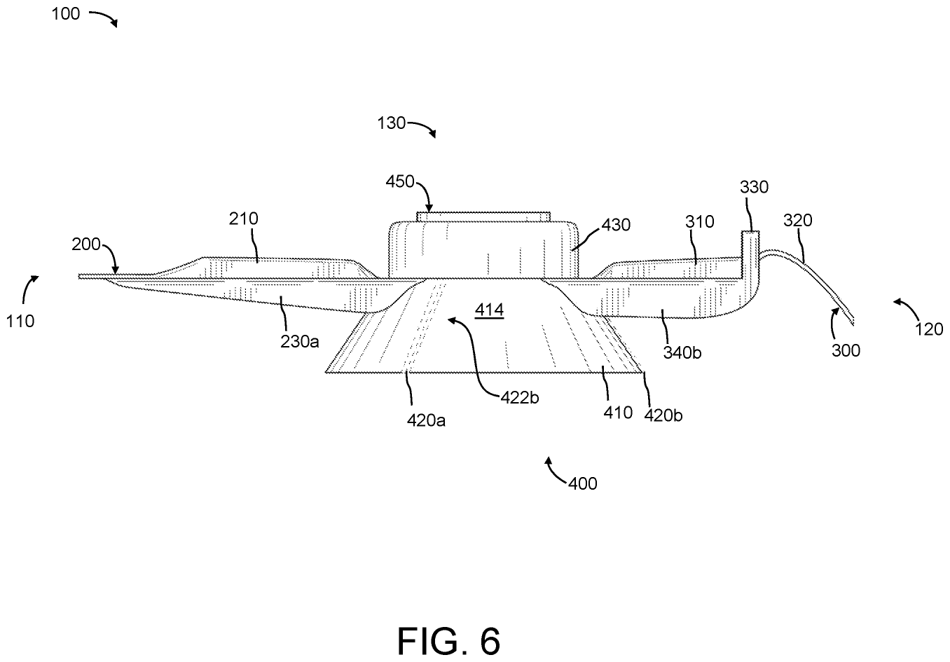

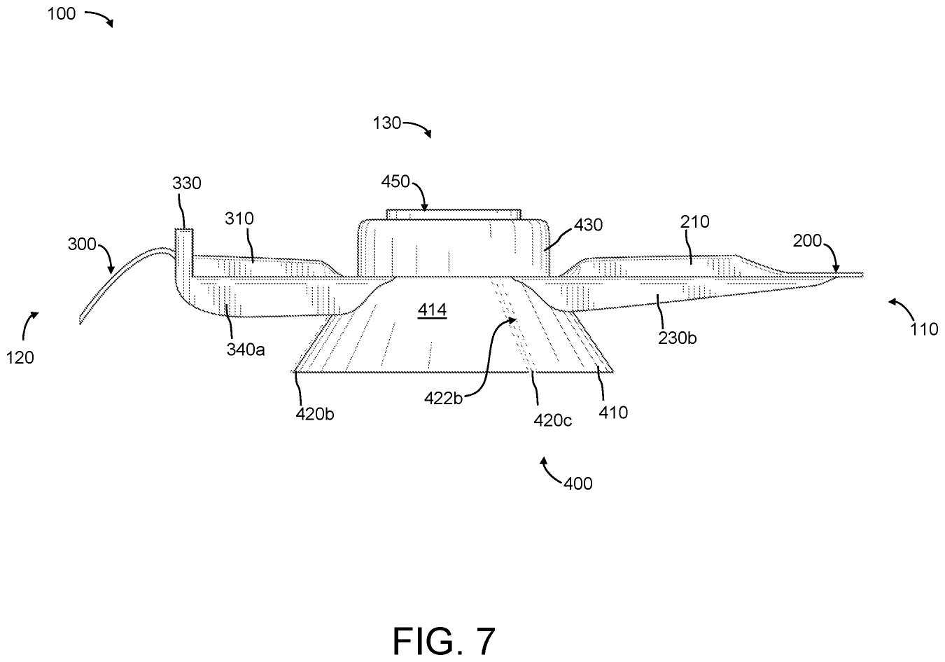

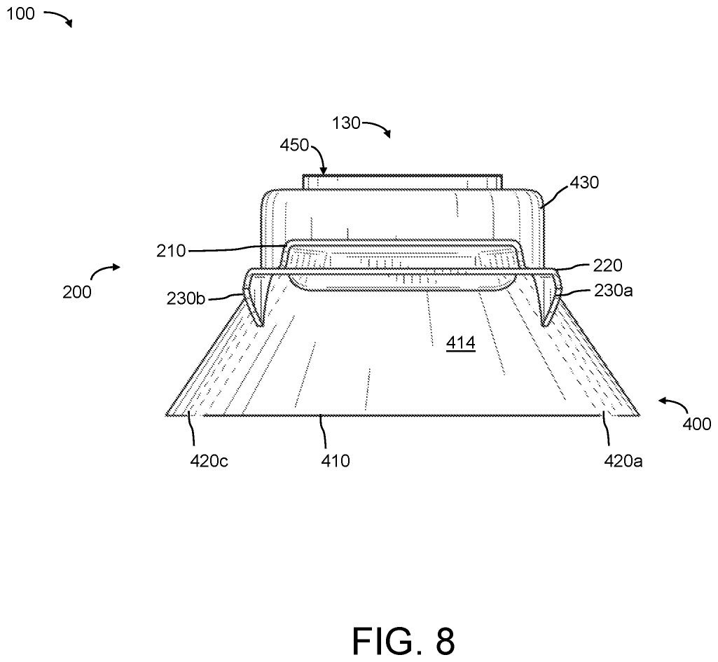

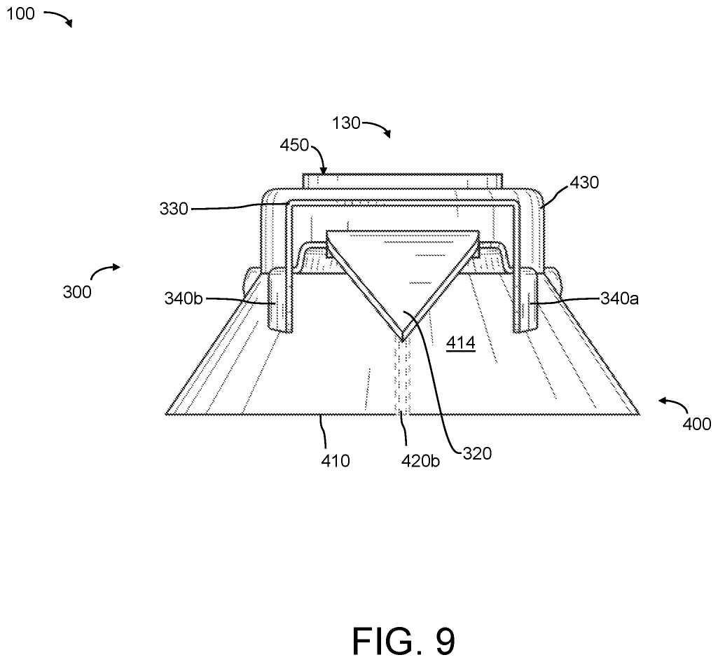

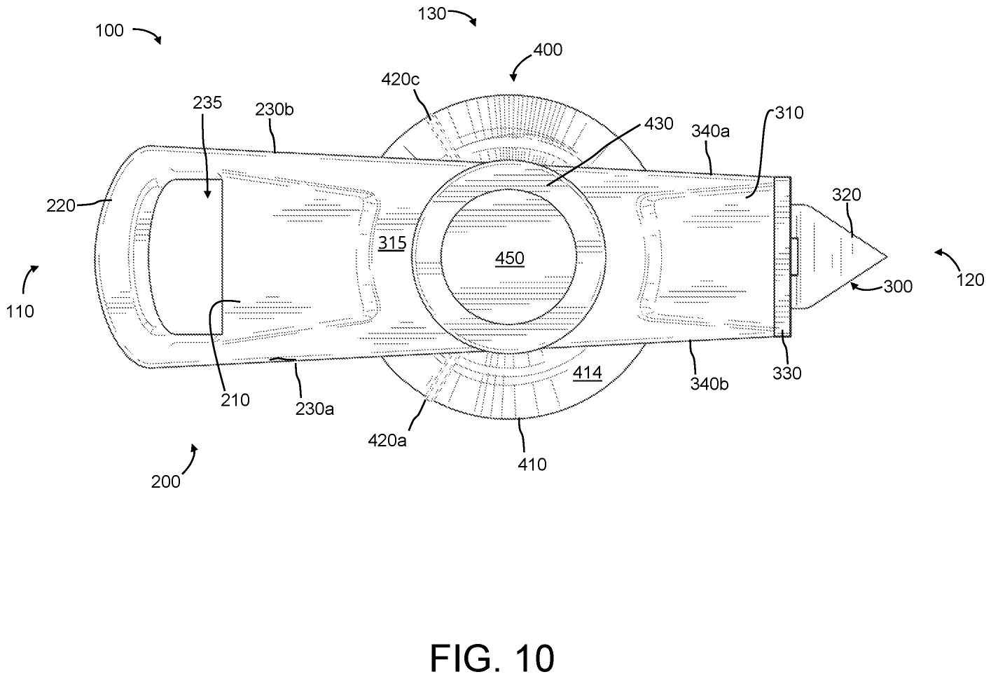

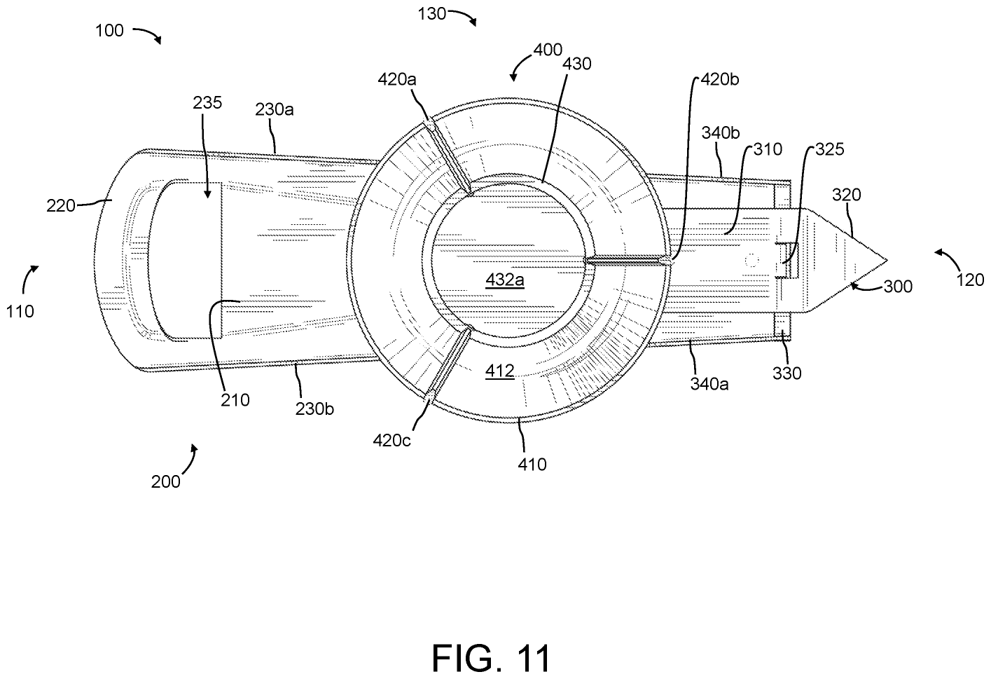

The frustoconical cap gripping element 400 includes one or more cap gripping ridges 420a,420b, etc. on its inner surface 412. Rather than engage with a vertical surface of a metal or plastic threaded cap, as known devices do, the cap gripping ridges 420a,420b, etc. of bottle opener and resealer devices 100 consistent with the present disclosure engage with the rim R (e.g., the region where the top of a cap and the vertical side wall(s) W of the cap meet, as shown in FIG. 4) of threaded metal or plastic caps. In this manner, the one or more cap gripping ridges 420a,420b, etc. are significantly better at gripping the threaded metal or plastic cap than known devices.

In some embodiments, the frustoconical cap gripping element 400 includes at least two cap gripping ridges 420a,420b, etc. on its inner surface 412. In some embodiments, the frustoconical cap gripping element 400 includes at least three cap gripping ridges 420a,420b, etc. on its inner surface 412. In some embodiments, the frustoconical cap gripping element 400 includes at least four cap gripping ridges 420a,420b, etc. on its inner surface 412. In some embodiments, the frustoconical cap gripping element 400 includes at least five cap gripping ridges 420a,420b, etc. on its inner surface 412. In some embodiments, the frustoconical cap gripping element 400 includes at least six cap gripping ridges 420a,420b, etc. on its inner surface 412. In some embodiments, the frustoconical cap gripping element 400 includes four cap gripping ridges 420a,420b,420c,420d on its inner surface 412. In some embodiments, the cap gripping ridges 420a,420b, etc. each include a relatively sharp innermost edge 422a.

In some embodiments, the progressively expanded gripping section 410 includes one or more finger grips 422b on its exterior surface 414. The one or more finger grips 422b may have any suitable profile shape that improves a user's grip on the exterior surface of the progressively expanded cap gripping section 410. In the embodiment shown in FIG. 1, for example, the one or more finger grips 422b generally have a beveled rectangular shape.

In some embodiments, the progressively expanded gripping section 410 includes at least 2 finger grips 422b. In some embodiments, the progressively expanded gripping section 410 includes at least three finger grips 422b. In some embodiments, the progressively expanded gripping section 410 includes at least four finger grips 422b. In some embodiments, the progressively expanded gripping section 410 includes at least five finger grips 422b. In some embodiments, the progressively expanded gripping section 410 includes at least six finger grips 422b. In some embodiments, such as the embodiment shown in FIG. 1, the progressively expanded gripping section 410 includes four finger grips 422b.

In some embodiments, each of the finger grips 422b on the outer surface 414 of the progressively expanding cap gripping section 410 aligns with a cap gripping ridge 420a,420b, etc. on the inner surface 412 of the progressively expanding cap gripping section 410. In some embodiments, a single unitary piece of material forms a finger grip 422b and a cap gripping ridge 422a; in such embodiments, the progressively expanded gripping section 410 is formed of an alternating pattern of (a) a finger grip 422b/cap gripping ridge 422a, and (b) a fractional section of the progressively expanded gripping section 410 material, as shown in FIG. 1.

In some embodiments, the bottle opener and resealer 100 includes a grip enhancing element 430. The grip enhancing element 430 may feature any suitable cross-sectional shape such as, for example, a circle, an oval, a triangle, a square, a rectangle, a pentagon, a hexagon, a heptagon, an octagon, a nonagon, a decagon, any other polygon, an ellipse, a rounded polygon, a rounded square, or a squircle.

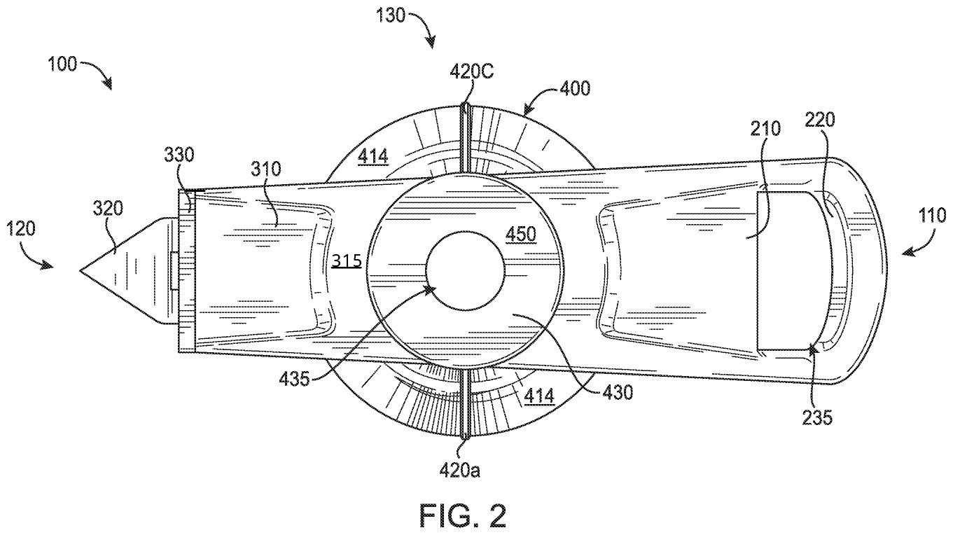

As shown in FIG. 2, the grip enhancing element 430 may include a top surface 450, which may be used to include information such as use instructions, a maker's mark, or an advertising feature. In some embodiments, the top surface 450 includes a void 435. In such embodiments, the void enhances a user's view of a cap to which the frustoconical cap gripping element 400 is applied and thus can help, for example, the user align the bottle opener and resealer 100 in an optimum orientation to the cap to maximize the force exerted on the cap during operation. In some embodiments, the grip enhancing element 430 may include an inner side wall surface 432 including an inner top surface 432a for pressing a crimp cap (also referred to as a crown cap) onto the opening of a bottle to seal the bottle.

In some embodiments, the grip enhancing element 430 may further include one or more cap gripping ridges 440a,440b, etc., on its inner side wall surface 432. In some embodiments, each cap gripping ridge 430a,430b, etc., is aligned with a cap gripping ridge 420a,420b, etc. on the inner surface 412 of the progressively expanded gripping section 410.

In some embodiments, the grip enhancing element 430 may include one or more cap teeth 442 on its inner side wall surface 432. In the embodiment shown in FIG. 1, for example, the one or more cap teeth 442 are generally triangular in shape, with one leg of the generally triangular shape along the side wall of the inner side wall surface 432 and another leg along the inner top surface 432a of the inner side wall surface 432. In some embodiments, the one or more cap teeth 442 may have another shape, such as a circle sector, a circle segment, a scallop, a quadrilateral, a pentagon, a hexagon, a heptagon, an octagon, a nonagon, etc.

In some embodiments, the grip enhancing element 430 includes two cap teeth 442 on its inner side wall surface 432. In such embodiments, the two cap teeth 442 are generally opposed, for example with one cap tooth 442 adjacent with one side wall (230a/340b) of the bottle opener and resealer 100 and the second tooth 442 adjacent with the opposing side wall (230b/340a) (e.g., with the two cap teeth separated by about 180° around the circular grip enhancing element 430).

In other embodiments, the grip enhancing element 430 may include more than two cap teeth 442, such as three cap teeth 442, four cap teeth 442, five cap teeth 442, six cap teeth 442, seven cap teeth 442, eight cap teeth 442, nine cap teeth 442, ten cap teeth 442, or more than ten cap teeth 442. In embodiments with more than two cap teeth 442, the cap teeth 442 may be distributed evenly (e.g., separated by the same distance or angle) from each other.

In some embodiments, the grip enhancing element 430 features a similar minimum diameter (or minimum width if other than a circular cross-sectional shape) as the minimum diameter or width of the frustoconical gripping element 400. In other embodiments, the grip enhancing element 430 features a relatively larger minimum diameter (or minimum width if other than a circular cross-sectional shape) as the minimum diameter or width of the frustoconical gripping element 400. In other embodiments, the grip enhancing element 430 features a relatively smaller minimum diameter (or minimum width if other than a circular cross-sectional shape) as the minimum diameter or width of the frustoconical gripping element 400.

Referring now to FIG. 1, the cap lever element 200 includes a fulcrum portion 210 and a cap-lifting edge 220 separated by a gap 235. The cap lever element 200 may be disposed at a first end 110 of the bottle opener and resealer 100.

The can piercer 300 includes a church key 320 disposed on one face of the bottle opener and resealer 100, with a corresponding church key lever 325 disposed on the opposite face of the bottle opener and resealer 100. In some embodiments, the can piercer 300 is disposed at a second end 120 of the bottle opener and resealer 100, for example that is opposite the first end 110 where a cap lever element 200 may be disposed as shown in FIG. 1.

The lift-tab bar 330 comprises a bar or strip of material disposed on and bridging the width of one face of the bottle opener and resealer 100. In the embodiment shown in FIG. 1, for example, the lift-tab bar 330 bridges the same face and second end 120 of the bottle opener and resealer 100 that features the church key 320. In other embodiments, the lift-tab bar 330 may bridge the width of the bottle opener and resealer 100 on the same face and at the first end 110 that features the cap lever element 200.

In some embodiments, a bottle opener and resealer 100 consistent with the present disclosure includes at least one side wall 230a,203b along a length of the fulcrum portion 210. The at least one side wall 230a,230b increases a user's leverage when applying a twisting force to the bottle opener and resealer 100. In some embodiments, the bottle opener and resealer 100 includes a first side wall 230a on a first side of the fulcrum portion 210, and a second side wall 230b on a second, opposing side of the fulcrum portion 210.

In some embodiments, a bottle opener and resealer 100 consistent with the present disclosure includes at least one side wall 340a,340b along a length of the base 310, such as between the frustoconical cap gripping element 400 and the can piercer 300. The at least one side wall 340a,340b increases a user's leverage when applying a twisting force to the bottle opener and resealer 100. In some embodiments, the bottle opener and resealer 100 includes a first side wall 340a on a first side of the base 310, and a second side wall 340b on a second, opposing side of the base 310.

In some embodiments, the present disclosure provides a bottle opener and resealer comprising a frustoconical cap gripping element disposed on a first, bottom face of the bottle opener and resealer, wherein the frustoconical cap gripping element is for engaging with a top rim of a bottle cap and comprises at least two cap gripping ridges disposed on an inner surface of the frustoconical cap gripping element.

In some embodiments, the present disclosure provides a bottle opener and resealer comprising: a cap-lever element at a first end of the bottle opener and resealer; a can piercer at a second end of the bottle opener and resealer; a lift-tab bar at the second end of the bottle opener and resealer and disposed on a top face of the bottle opener and resealer; a frustoconical cap gripping element for engaging with a top rim R of a bottle cap C, the frustoconical cap gripping element disposed between the first end and the second end of the bottle opener and resealer and on a bottom face of the bottle opener and resealer, the frustoconical cap gripping element comprising cap gripping ridges through a thickness of the frustoconical cap gripping element; and a grip enhancing element between the first end and the second end of the bottle opener and resealer and disposed on the top face of the bottle opener and resealer, the grip enhancing element comprising four cap gripping ridges disposed on an inner side wall surface of the grip enhancing element.

In some embodiments, the present disclosure provides a bottle opener and resealer comprising: a cap-lever element at a first end of the bottle opener and resealer; a can piercer at a second end of the bottle opener and resealer; and a frustoconical cap gripping element for engaging with a top rim R of a bottle cap C, the frustoconical cap gripping element disposed between the first end and the second end of the bottle opener and resealer. In some embodiments, the frustoconical cap gripping element has a maximum inner diameter of about 3 inches. In some embodiments, the frustoconical cap gripping element has a minimum inner diameter of about 1 inch. In some embodiments, the frustoconical cap gripping element includes a plurality of cap gripping ridges along its inner surface. In some embodiments, the frustoconical cap gripping element includes at least 3 cap gripping ridges. In some embodiments, the frustoconical cap gripping element includes at least 4 cap gripping ridges. In some embodiments, the frustoconical cap gripping element includes 4 cap gripping ridges. In some embodiments, the bottle opener and resealer further comprises at least one side wall between the frustoconical cap gripping element and the cap-lever element. In some embodiments, the bottle opener and resealer further comprises at least one side wall between the frustoconical cap gripping element and the can piercer. In some embodiments, the bottle opener and resealer further comprises a grip enhancing element between the first end and the second end of the bottle opener and resealer and disposed on the top face of the bottle opener and resealer, the grip enhancing element comprising four cap gripping ridges disposed on an inner side wall surface of the grip enhancing element. In some embodiments, the bottle opener and resealer further comprises a lift-tab bar at the second end of the bottle opener and resealer and disposed on a top face of the bottle opener and resealer. In some embodiments, the bottle opener and resealer further comprises a plurality of finger grips disposed on an exterior surface of the frustoconical cap gripping element. In some embodiments, each of the plurality of finger grips on the exterior surface of the frustoconical cap gripping element and each of the cap gripping ridges on the inner surface of the frustoconical cap gripping element are a single unitary piece of material.

2. Methods of Opening and Resealing a Bottle

The present disclosure also provides methods of opening a bottle B using a bottle opener and resealer 100 consistent with the present disclosure. Generally, the method comprises engaging the rim R of a bottle cap C of a bottle B, and thereafter applying a force to the bottle opener and resealer 100 to loosen the cap C from the bottle B. In some embodiments, the method comprises engaging the rim R of the bottle cap C without engaging a side wall W of the bottle cap C.

In some embodiments, the method comprises engaging a crimped (press-fit or crown) or threaded metal cap on a bottle using the cap lever element 200 at the first end 110 of a bottle opener and resealer 100 consistent with the present disclosure. Thereafter, a lifting or pushing force is applied by the user to the second end 120, opposite the first end 110, to pry the crimped metal cap off of the bottle.

In some embodiments, the method comprises engaging the rim of a threaded metal cap on a bottle using the one or more cap gripping ridges 420a,420b, etc. of the frustoconical cap gripping element 400 of a bottle opener and resealer 100 consistent with the present disclosure. Thereafter, a twisting force is applied to by the user to the bottle opener and resealer 100 to loosen the threaded metal cap from the bottle. In some embodiments, the method comprises engaging the one or more cap gripping ridges 420a,420b, etc. of the frustoconical cap gripping element 400 of a bottle opener and resealer 100 consistent with the present disclosure to the rim of the threaded metal cap, but not engaging any portion of the bottle opener and resealer 100 to a side wall of the threaded metal cap.

Referring now specifically to FIG. 4, the method in some embodiments comprises engaging the rim R of a threaded plastic cap C on a bottle B using the one or more cap gripping ridges 420a,420b, etc. of the frustoconical cap gripping element 400 of a bottle opener and resealer 100 consistent with the present disclosure. Thereafter, a twisting force is applied to by the user to the bottle opener and resealer 100 to loosen the threaded plastic cap C from the bottle B. In some embodiments, the method comprises engaging the rim R of a threaded plastic cap C on a bottle B using the one or more cap gripping ridges 420a,420b, etc. of the frustoconical cap gripping element 400 without engaging any portion of the bottle opener and resealer 100 with a side wall W of the threaded plastic cap C. In some embodiments, the method additionally loosens the threaded plastic cap C from a tamper ring T associated with the threaded plastic cap C.

In some embodiments, the method comprises engaging the rim of a metal can using the church key lever 325 of the can piercer 300 disposed at a second end 120 of a bottle opener and resealer 100 consistent with the present disclosure. Thereafter, the method comprises applying a lifting force by a user to the first end 110, opposite the second end 120, to pierce the lid of the metal can.

The present disclosure also provides methods of resealing an open bottle using a crimped (press-fit or crown) metal cap and a bottle opener and resealer 100 consistent with the present disclosure. Generally, the method comprises placing the cap on the opening of the bottle, engaging the fulcrum portion 210 of the bottle opener and resealer 100 with the crimped metal cap, and thereafter applying a force to the bottle opener and resealer 100 to secure the cap to the bottle. Alternatively, the method comprises placing the cap on the opening of the bottle, engaging the inner top surface 432a of the grip enhancing element 430 with the crimped metal cap, and thereafter applying a force to the grip enhancing element 430 to secure the cap to the bottle.

In some embodiments, the method comprises securing a crimped (press-fit or crown) or threaded metal cap on the opening of a bottle. Thereafter, the fulcrum portion 210 of a cap lever element 200 at the first end 110 of a bottle opener and resealer 100 consistent with the present disclosure is engaged with the top of the cap, and a pushing force is applied to the fulcrum portion 210 to force the crimped metal cap onto the opening of the bottle. Alternatively, the method comprises engaging the inner top surface 432a of the grip enhancing element 430 with the top of the cap, and thereafter applying a pushing force to the grip enhancing element 430 to secure the cap to the bottle. In some embodiments, the crimped metal cap has a bend in its shape (e.g., from being pried off of a bottle), and the step of applying the pushing force straightens the bent metal cap sufficiently to enable the cap to seal around the outer rim of the bottle opening.

In some embodiments, the method comprises securing a threaded metal cap on a bottle by applying force to only the rim (e.g., but not to a side wall) of the threaded metal cap. The method comprises placing the threaded metal cap on the bottle opening, engaging the one or more cap gripping ridges 420a,420b, etc. of the frustoconical cap gripping element 400 of a bottle opener and resealer 100 consistent with the present disclosure to the rim of the threaded metal cap, and thereafter, applying a twisting force to the bottle opener and resealer 100 to secure the threaded metal cap to the bottle. In some embodiments, the method comprises engaging the one or more cap gripping ridges 420a,420b, etc. of the frustoconical cap gripping element 400 of a bottle opener and resealer 100 consistent with the present disclosure to the rim of the threaded metal cap, but not engaging any portion of the bottle opener and resealer 100 to a side wall of the threaded metal cap.

Referring now specifically to FIG. 4, the method in some embodiments comprises securing a threaded plastic cap C on a bottle B by applying force to only the rim R (e.g., but not to a side wall W) of the threaded plastic cap C. The method comprises placing the threaded plastic cap C on the opening of the bottle B, engaging the one or more cap gripping ridges 420a,420b, etc. of the frustoconical cap gripping element 400 of a bottle opener and resealer 100 consistent with the present disclosure to the rim R of the threaded plastic cap C, and thereafter, applying a twisting force to the bottle opener and resealer 100 to secure the threaded plastic cap C to the bottle B. In some embodiments, the method comprises engaging the one or more cap gripping ridges 420a,420b, etc. of the frustoconical cap gripping element 400 of a bottle opener and resealer 100 consistent with the present disclosure to the rim R of the threaded plastic cap C, but not engaging any portion of the bottle opener and resealer 100 to a side wall W of the threaded plastic cap C.

### EXAMPLES

### Example 1

A bottle opener and resealer 100 including a frustoconical cap gripping element 400 with three equally-distributed cap gripping ridges 420a,420b,420c but otherwise consistent with the embodiment shown in FIGS. 1-4 was constructed of NSF-approved steel. The maximum diameter of the progressively expanded gripping section 410 was about 2 inches, and the minimum diameter of the progressively expanded gripping section 410 was about 1.25 inches.

The bottle opener and resealer 100 successfully opened and resealed bottles having various types of caps, including crimped (press-fit) metal caps, threaded metal caps, and threaded plastic caps.

### Example 2

A bottle opener and resealer 100 including a frustoconical cap gripping element 400 with four equally-distributed cap gripping ridges 420a,420b,420c,420d and generally consistent with the embodiment shown in FIGS. 1-4 was constructed of NSF-approved steel. The maximum diameter of the progressively expanded gripping section 410 was about 2 inches, and the minimum diameter of the progressively expanded gripping section 410 was about 1.25 inches.

The bottle opener and resealer 100 successfully opened and resealed bottles having various types of caps, including crimped (press-fit) metal caps, threaded metal caps, and threaded plastic caps. Comparatively, the bottle opener and resealer 100 of this Example 2 performed better than the bottle opener and resealer 100 of Example 1. More specifically, the orientation (e.g., the horizontal plane) of the bottle opener and resealer 100 of this Example 2 was more stable relative to the orientation of the threaded plastic or metal cap when a twisting force was applied compared to the stability of the orientation of the bottle opener and resealer 100 of Example 1.

1. A bottle opener and resealer comprising:
a cap-lever element at a first end of the bottle opener and resealer;
a can piercer at a second end of the bottle opener and resealer;
a lift-tab bar at the second end of the bottle opener and resealer and disposed on a top face of the bottle opener and resealer;
a frustoconical cap gripping element configured to engage only a top rim of a bottle cap, the frustoconical cap gripping element disposed between the first end and the second end of the bottle opener and resealer and on a bottom face of the bottle opener and resealer, the frustoconical cap gripping element comprising cap gripping ridges disposed on an inner surface of the frustoconical cap gripping element, the cap gripping ridges configured to engage only the top rim of the bottle cap; and
a grip enhancing element disposed between the first end and the second end of the bottle opener and resealer and disposed on the top face of the bottle opener and resealer, the grip enhancing element comprising:
four cap gripping ridges disposed on an inner side wall surface of the grip enhancing element, and
two cap teeth disposed on the inner side wall surface and an inner top surface of the grip enhancing element.

2. A bottle opener and resealer comprising:
a frustoconical cap gripping element disposed on a first, bottom face of the bottle opener and resealer,
wherein the frustoconical cap gripping element is configured to engage only a top rim of a bottle cap and comprises at least two cap gripping ridges disposed on an inner surface of the frustoconical cap gripping element.

3. A bottle opener and resealer comprising:
a frustoconical cap gripping element configured to engage only a top rim of a bottle cap, the frustoconical cap gripping element disposed on a bottom face of the bottle opener and resealer, the frustoconical cap gripping element comprising cap gripping ridges disposed on an inner surface of the frustoconical cap gripping element, the cap gripping ridges configured to engage only the top rim of the bottle cap; and
a cylindrical grip enhancing element disposed on a top surface of the bottle opener and resealer, the cylindrical grip enhancing element comprising:
a plurality of cap gripping ridges disposed on an inner side wall surface of the cylindrical grip enhancing element, and
at least two cap teeth disposed on the inner side wall surface and an inner top surface of the grip enhancing element.

4. The bottle opener and resealer of claim 3, wherein the frustoconical cap gripping element has a maximum inner diameter of about 2 inches.

5. The bottle opener and resealer of claim 3, wherein the frustoconical cap gripping element has a minimum inner diameter of about 1.25 inches.

6. The bottle opener and resealer of claim 3, wherein the frustoconical cap gripping element includes a plurality of cap gripping ridges along its inner surface.

7. The bottle opener and resealer of claim 6, wherein the frustoconical cap gripping element includes at least 3 cap gripping ridges.

8. The bottle opener and resealer of claim 6, wherein the frustoconical cap gripping element includes at least 4 cap gripping ridges.

9. The bottle opener and resealer of claim 6, wherein the frustoconical cap gripping element includes 4 cap gripping ridges.

10. The bottle opener and resealer of claim 3 further comprising a cap-lever element at a first end of the bottle opener and resealer.

11. The bottle opener and resealer of claim 3 further comprising a can piercer at a second end of the bottle opener and resealer.

12. (canceled)

13. The bottle opener and resealer of claim 1, wherein the grip enhancing element further comprises at least two cap teeth disposed on the inner surface of the grip enhancing element and on an inner top surface of the grip enhancing element.

14. The bottle opener and resealer of claim 3 further comprising a lift-tab bar at the second end of the bottle opener and resealer and disposed on a top face of the bottle opener and resealer.

15. The bottle opener and resealer of claim 3 further comprising a plurality of finger grips disposed on an exterior surface of the frustoconical cap gripping element.

16. The bottle opener and resealer of claim 15, wherein each of the plurality of finger grips on the exterior surface of the frustoconical cap gripping element and each of the cap gripping ridges on the inner surface of the frustoconical cap gripping element are a single unitary piece of material.

17. (canceled)

18. (canceled)

19. The bottle opener and resealer of claim 3 wherein, when lowered onto a bottle cap, the frustoconical cap gripping element engages a top rim of a bottle cap without engaging with a side wall of the bottle cap.

20. The bottle opener and resealer of claim 1, wherein the diameter of the frustoconical cap gripping element at the maximum inner diameter relative to the minimum inner diameter is a ratio of greater than or equal to about 2:1.25.
